(19) United States
(12) Patent Application Publication
(10) Pub. No.: US 2010/0175517 A1
(43) Pub. Date: Jul. 15, 2010

(54) BICYCLE TOOL

(75) Inventors: Toshio Tetsuka, Ashiya City (JP); Takeshi Takachi, Kawachinagano City (JP)

Correspondence Address: DELAND LAW OFFICE, P.O. BOX 69, KLAMATH RIVER, CA, 96050-0069, US

(73) Assignee: Shimano, Inc., Sakai City (JP)

(21) Appl. No.: 12/354,257

(22) Filed: Jan. 15, 2009

(51) Int. Cl. B25B 11/00

(52) U.S. Cl. 81/484

(57) ABSTRACT

A bicycle tool comprises a tool body, wherein the tool body includes a magnetic material; a magnet; and a connector. The connector is movably coupled between the tool body and the magnet.

### BACKGROUND OF THE INVENTION

The present invention is directed to bicycle tools and, more particularly, to a bicycle tool that can draw a component through the inner portion of a hollow bicycle member.

Bicycles typically include a frame, a front fork rotatably mounted to the front of the frame, a handlebar assembly mounted to the upper part of the fork, a front wheel rotatably attached to the lower part of the fork, a rear wheel rotatably attached to the rear of the frame, and a drive unit including pedals for communicating rotational force from the rider to the rear wheel. The frame, fork, and handlebar assembly typically comprise tubes bonded together in various configurations, and it is sometimes desirable to route cables and other components through one or more of the tubes.

### SUMMARY OF THE INVENTION

The present invention is directed to various features of a bicycle tool. In one embodiment, a bicycle tool comprises a tool body, wherein the tool body includes a magnetic material; a magnet; and a connector. The connector is movably coupled between the tool body and the magnet. Additional inventive features will become apparent from the description below, and such features alone or in combination with the above features and their equivalents may form the basis of further inventions as recited in the claims.

### BRIEF DESCRIPTION OF THE DRAWINGS

FIG. 1 is a side view of a bicycle;

FIG. 2 is a side view of a tool kit for the bicycle;

FIG. 3 is a side view of a first tool with a magnet retained to the tool body;

FIG. 4 is a schematic view illustrating how the tool kit is used to route a cable through a bicycle tube; and

FIG. 5 is a schematic view illustrating how the tool kit is used to route a cable through a bicycle tube.

### DETAILED DESCRIPTION OF THE EMBODIMENTS

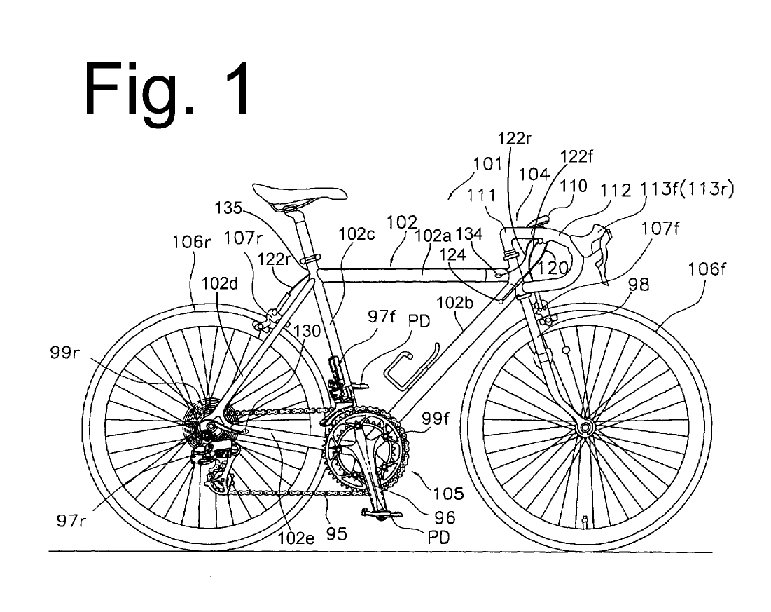

FIG. 1 is a side view of a bicycle 101. In this embodiment, bicycle 101 is a road bicycle comprising a diamond-shaped frame 102 including a top tube 102a, a down tube 102b, a seat tube 102c, a pair of seat stays 102d, and a pair of chain stays 102e; a front fork 98 rotatably mounted to the front of frame 102; a handlebar assembly 104 mounted to the upper part of fork 98; a front wheel 106f rotatably attached to the lower part of fork 98; a rear wheel 106r rotatably attached to the rear of frame 102; and a drive unit 105. A front wheel brake 107f is provided for braking front wheel 106f, and a rear wheel brake 107r is provided for braking rear wheel 106r.

Drive unit 105 comprises a chain 95, a front sprocket assembly 99f coaxially mounted with a crank 96 having pedals PD, an electrically-controlled front derailleur 97f attached to seat tube 102c, a rear sprocket assembly 99r coaxially mounted with rear wheel 106r, and an electrically-controlled rear derailleur 97r. Front sprocket assembly 99f comprises two coaxially mounted sprockets, and rear sprocket assembly 99r comprises ten sprockets mounted coaxially with an axle of rear wheel 106r. Front derailleur 97f moves to two operating positions to switch chain 95 between the two front sprockets, and rear derailleur 97r moves to ten operating positions to switch chain 95 among selected ones of the ten rear sprockets.

A handlebar stem 111 is mounted to the upper portion of front fork 98, and a drop-style handlebar 112 is mounted to a front portion of handlebar stem 111. A combined brake and shift control device 113f is mounted to the left side of handlebar 112 to control the operation of front derailleur 97f and front brake 107f, and a combined brake and shift control device 113r is mounted to the right side of handlebar 112 to control the operation of rear derailleur 97r and rear brake 107r. An electronic control unit 110 provides the appropriate electrical signals to front derailleur 97f and rear derailleur 97r through an electrical wire assembly 120 routed through the hollow portion of down tube 102b. Electrical signals from combined brake and shift control devices 113f and 113r are communicated to electronic control unit 110 through electrical further wire assembles (not shown). The brake control device in brake and shift control device 113f controls front brake 107f through a Bowden cable assembly 122f, and the brake control device in combined brake and shift control device 113r controls rear brake 107r through a Bowden cable assembly 122r routed through the hollow portion of top tube 102a.

In this embodiment, electrical wire assembly 120 enters the upper portion of down tube 102b through an opening 124. The portion of electrical wire assembly 120 that controls the operation of front derailleur 97f exits the lower portion of down tube 102b through another opening (not shown), and the portion of electrical wire assembly 120 that controls the operation of rear derailleur 97r exits the rear of right-side chain stay 102e through an opening 130. Similarly, Bowden cable assembly 122r enters the front portion of top tube 102a through an opening 134, and Bowden cable assembly 122r exits the rear of top tube 102a through an opening 135 in seat tube 102c.

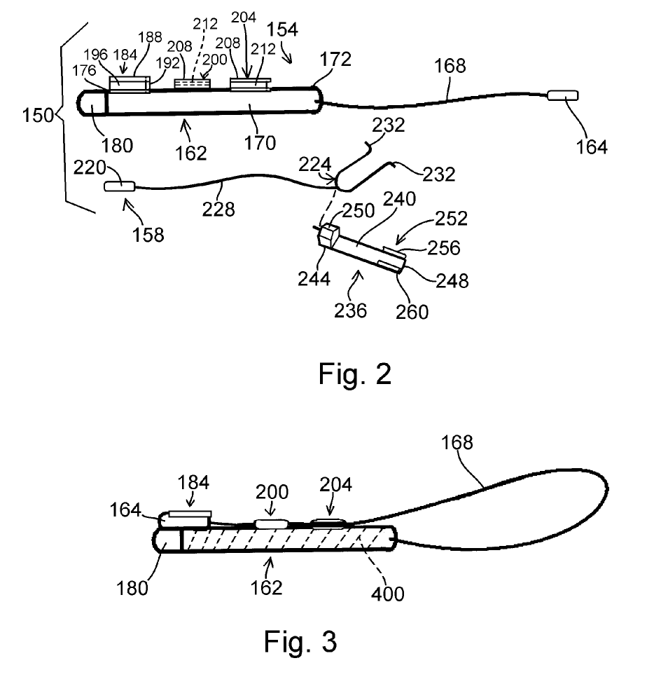

In order to facilitate the routing of electrical wire assembly 120 and Bowden cable assembly 122r through down tube 102b and top tube 102a, respectively, the tool kit 150 shown in FIG. 2 may be used. Tool kit 150 comprises a first tool 154 and a second tool 158. First tool 154 comprises a generally cylindrical rod-shaped tool body 162, a magnet 164, and a flexible connector 168. Tool body 162 comprises a body portion 170 with a first end portion 172 and a second end portion 176, wherein flexible connector 168 is detachably or non-detachably attached to first end portion 172, and a magnetic material 180 is disposed at second end portion 176.

In this embodiment, flexible connector 168 comprises a filament member. Preferably, but not necessarily, flexible connector 168 is semi-rigid and may even be substantially non-compressible along the longitudinal axis thereof. For example, flexible connector 168 may comprise a metal wire that may be solid, braided, wound, and so on. In this embodiment, flexible connector 168 is a wound metal wire similar in construction to the inner wire of a Bowden cable used for bicycle brake or derailleur control devices.

In this embodiment, magnet 164 is a generally oval-shaped cylinder, and it is detachably or non-detachably connected to the other end of flexible connector 168. Magnet 164 may be a permanent magnet, an electromagnet, etc. Magnet 164 may have one or more rounded ends as shown in FIG. 2, one or more chamfered ends as shown in FIG. 5, or some other configuration that may help magnet 164 travel through the interior of the hollow bicycle member.

Magnetic material 180 maybe a material that can be magnetized (e.g., iron that can be made magnetic by contact with magnet 164, for example), or it can be another magnet similar to magnet 164. Magnetic material 180 may have one or more rounded ends, one or more chamfered ends, or some other configuration that may help magnetic material 180 move along the outer face of the bicycle structure through which electrical wire assembly 120, Bowden cable assembly 122r, or some other component passes. In this embodiment, the portion of tool body 162 that extends from magnetic material 180 toward flexible connector 168 is formed of a non-magnetic material such as plastic.

A magnet retainer 184 is disposed at second end portion 176 of body portion 170 for retaining magnet 164 to tool body 162. In this embodiment, magnet retainer 184 has an arcuate shape dimensioned to engage magnet 164 to retain magnet 164 against tool body 162. More specifically, magnet retainer 184 comprises a tubular cylindrical member 188 dimensioned to receive magnet 164 therein. An end wall 192 is formed on the right-side end of cylindrical member 188 to form a floor that prevents magnet 164 from being pulled out of magnet retainer 184 by inadvertent pulling of flexible connector 168. A slot 196 extends through an entire length of the side wall of cylindrical member 188 and into end wall 192. Slot 196 is dimensioned to receive flexible connector 168 therethrough so that magnet 164 may be inserted into magnet retainer 184 simply by passing flexible connector through slot 196 while magnet 164 is disposed to the left of magnet retainer 184 and then by pulling flexible connector 168 to seat magnet 164 inside magnet retainer 184 as shown in FIG. 3. In some applications, magnet retainer 184 retains magnet 164 sufficiently close to magnetic material 180 to magnetize magnetic material 180. For example, magnet retainer 184 may cause magnet 164 to contact magnetic material 180.

Alternating connector retainers 200 and 204 are disposed on body portion 170 to retain flexible connector 168 to tool body 162 as shown in FIG. 3. Each connector retainer 200 and 204 comprises a tubular cylindrical member 208 with a slot 212 extending through a side wall thereof Slots 212 are dimensioned for receiving flexible connector 168 therethrough. Slot 212 in connector retainer 200 faces in the opposite direction from slot 212 in connector retainer 204, so slot 212 in connector retainer 200 is hidden from view in FIGS. 2 and 3.

In this embodiment, second tool 158 comprises a magnet 220, a component coupler 224 and a flexible connector 228. Flexible connector 228 is detachably or non-detachably connected to magnet 220 and to component coupler 224. As with magnet 164 in first tool 154, magnet 220 may be many types of magnets (e.g., permanent magnet, electromagnet, etc.) having many forms. While flexible connector 228 may be a wire having the same characteristics as flexible connector 168 in first tool 154, in this embodiment flexible connector 228 preferably is a very flexible, easily deformable filament such as a string.

Component coupler 224 is dimensioned to couple to a component that is to be pulled through an inner portion of the hollow bicycle member. In this embodiment, component coupler 224 comprises a hook with a generally U-shape. Coupling prongs 232 extend outwardly in opposite directions from the free end of the U to facilitate coupling to a component, such as an electrical socket, to be pulled through the interior of the hollow bicycle member.

Component coupler 224 may have many different configurations depending upon the configuration of the component to be pulled through the interior of the hollow bicycle member. For example, a component coupler 236 may be used to pull an electrical plug through the interior of the hollow bicycle member. In this case, component coupler 236 comprises an elongated coupler body 240 having a first end portion 244 and a second end portion 248, wherein first end portion 244 includes a coupling base 250 coupled flexible connector 228. A component retainer 252 is coupled to coupler body 240 and is displaced from first end portion 244. In this embodiment, component retainer 252 comprises first and second mounting projections 256, 260 that extend in parallel from second end portion 248 of coupler body 240 to form a clip for retaining the component to coupler body 240. If desired, a detachable coupler may be disposed on component coupler 224 or component coupler 236 so that they may be detachably coupled to flexible connector 228 depending upon the application.

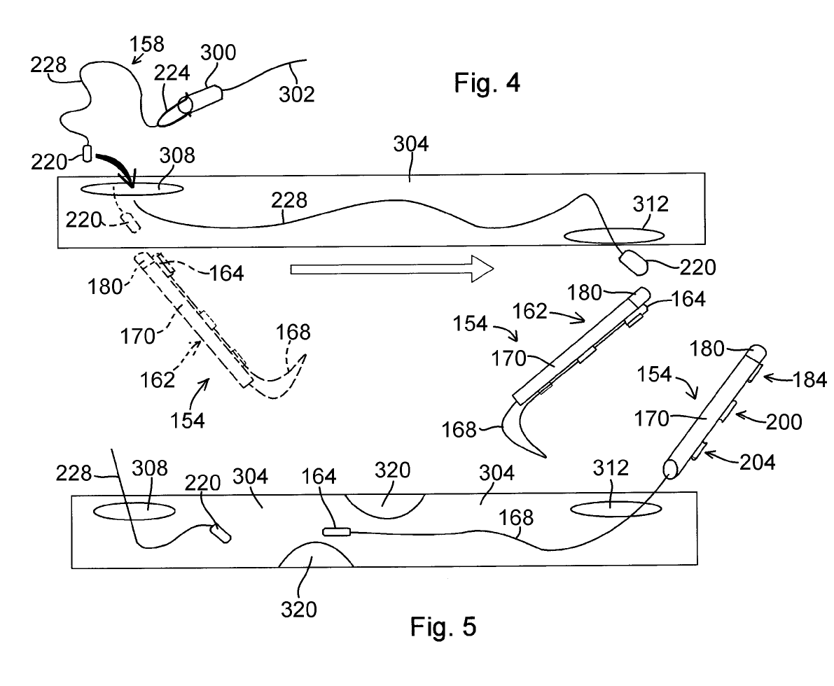

The operation of tool 150 is illustrated in FIGS. 4 and 5. FIG. 4 shows the pulling of an electrical socket 300 attached to a wire 302 through a non-magnetizable (e.g., carbon or aluminum) tube member 304 having openings 308 and 312, wherein the interior of tube member 304 is uniform and substantially unobstructed. Initially, component coupler 224 of second tool 158 is attached to socket 300. Then, magnet 220 of second tool 158 is inserted through opening 308 in tube member 304 while holding the magnetic material 180 of first tool 154 against tube member 304 until magnet 220 is magnetically coupled to magnetic material 180. Magnetic material 180 then is slid along tube member 304 towards opening 312 in tube member 304. Since magnet 220 is magnetically coupled to magnetic material 180 during that time, magnet 220 slides along the inner surface of tube member 304 towards opening 312 together with magnetic material 180. Simultaneously, flexible connector 228 of second tool 158 is fed through opening 308 in tube member 304. When magnet 220 reaches opening 312, magnet 220 may be pulled out of tube member 304. Then, flexible connector 228 is pulled until component coupler 224, socket 300 and wire 302 are pulled though opening 308, through the inside of tube member 304, and then out through opening 312.

Sometimes, the interior of tube member 304 may have obstructions such as obstructions 320 schematically shown in FIG. 5. Obstructions 320 may prevent the use of the method shown in FIG. 4 because magnet 220 may become lodged against one of the obstructions. Accordingly, the method shown in FIG. 5 may be used in such situations. As shown in FIG. 5, magnet 220 of second tool 158 is inserted though opening 308. Then, magnet 164 and flexible connector 168 of first tool 154 are detached from their respective magnet retainer 184 and connector retainers 200 and 204, and magnet 164 is inserted through opening 312. Since flexible connector 168 is semi-rigid along its longitudinal axis (i.e., sufficiently rigid such that flexible connector 168 can push past typical obstructions for the particular application), magnet 164 may be pushed past obstructions 320 until magnet 164 magnetically couples with magnet 220. Thereafter, flexible connector 168 may be pulled to draw both magnet 164 and magnet 220 around obstructions 320 and through the inside of tube member 304. After magnet 164 and magnet 220 are pulled through opening 312, flexible connector 228 is pulled until component coupler 224, socket 300 and wire 302 are likewise pulled out though opening 308.

While the above is a description of various embodiments of inventive features, further modifications may be employed without departing from the spirit and scope of the present invention. For example, winding grooves 400 shown in FIG. 3 may be provided instead of or in addition to connector retainers 200 and 204 so that flexible connector 168 may be wound at tool body 162. While component couplers 224 and 236 were coupled to magnet 220 through flexible connector 228, component couplers could be directly coupled to magnet 220 or be formed integrally as a part of magnet 220.

The size, shape, location or orientation of the various components may be changed as desired. Components that are shown directly connected or contacting each other may have intermediate structures disposed between them. Separate components may be combined, and vice versa. The functions of one element may be performed by two, and vice versa. The function of one element may be performed by another, and functions may be interchanged among the elements. The structures and functions of one embodiment may be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Terms of degree such as “substantially,” “about” and “approximately” as used herein include a reasonable amount of deviation of the modified term such that the end result is not significantly changed. For example, such terms may include a deviation of at least ±5% of the modified term as long as such a deviation would not negate the meaning of the word it modifies. Thus, the scope of the invention should not be limited by the specific structures disclosed or the apparent initial focus or emphasis on a particular structure or feature.

What is claimed is:

1. A bicycle tool comprising:
a tool body;
a first magnet; and
a connector movably coupled between the tool body and the first magnet;
wherein the tool body includes a magnetic material.

2. The tool according to claim 1 wherein the connector is detachably coupled to at least one of the tool body or the first magnet.

3. The tool according to claim 1 wherein the connector is non-detachably coupled to the tool body and to the first magnet.

4. The tool according to claim 1 wherein the connector is flexible.

5. The tool according to claim 1 wherein the magnetic material comprises a second magnet.

6. The tool according to claim 1 wherein the tool body has a first end portion and a second end portion, wherein the flexible connector is disposed at the first end portion, and wherein the magnetic material is disposed at the second end portion.

7. The tool according to claim 6 wherein the tool body is rod-shaped.

8. The tool according to claim 7 wherein the tool body comprises a non-magnetic body portion that extends from the magnetic material.

9. The tool according to claim 1 wherein the first magnet has a rounded end.

10. The tool according to claim 1 wherein the first magnet has a chamfered end.

11. The tool according to claim 1 further comprising a magnet retainer disposed on the tool body for retaining the first magnet to the tool body.

12. A bicycle tool kit comprising:
a first tool including:
a first tool body;
a first magnet; and
a first connector movably coupled between the first tool body and the first magnet;
a second tool including:
a second magnet; and
a component coupler that couples to a component that is to be pulled through an inner portion of a hollow bicycle member, wherein the component coupler is coupled to the second magnet.

13. The tool kit according to claim 12 wherein the component coupler comprises a hook.

14. The tool kit according to claim 12 wherein the component coupler comprises:
an elongated coupler body having first and second end portions, wherein the first end portion of the coupler body is coupled to the second magnet; and
a component retainer coupled to the coupler body and displaced from the first end portion.

15. The tool kit according to claim 14 wherein the component retainer comprises first and second mounting projections that extend from the coupler body to form a clip for retaining the component to the coupler body.

16. The tool kit according to claim 12 further comprising a second connector movably coupled between the component coupler and the second magnet.

17. The tool according to claim 16 wherein the second connector is detachably coupled to at least one of the component coupler or the second magnet.

18. The tool according to claim 16 wherein the second connector is non-detachably coupled to the component coupler and to the second magnet.

19. The tool according to claim 12 wherein the first connector is flexible.

20. The tool according to claim 19 wherein the first tool body has a first end portion and a second end portion, wherein the first connector is disposed at the first end portion of the first tool body, and wherein a third magnet is disposed at the second end portion of the first tool body.
